(19) United States
(12) Patent Application Publication
(10) Pub. No.: US 2007/0157355 A1
(43) Pub. Date: Jul. 12, 2007

(54) Engineered toweling

(76) Inventor: Daniel H. Katsin, Mill Valley, CA (US)

Correspondence Address: DERGOSITS & NOAH LLP, FOUR EMBARCADERO CENTER, SUITE 1450, SAN FRANCISCO, CA, 94111, US

(21) Appl. No.: 11/644,600

(22) Filed: Dec. 22, 2006

Related U.S. Application Data
(60) Provisional application No. 60/753,687, filed on Dec. 22, 2005.

(51) Int. Cl. B32B 5/22; A41D 13/06; B32B 27/12; A47C 31/00; B65D 65/02

(52) U.S. Cl. 2/22; 442/286; 442/239; 442/76; 150/158; 297/219.1; 2/23

(57) ABSTRACT

The present invention is directed to articles of manufacture for drying or wiping a surface or protecting a surface from soiling. In one embodiment, a seat cover is described. In another embodiment, a fishing chap is described. In still another embodiment, a wiping and cleaning article is described.

### FIELD OF INVENTION

The present invention relates to articles of manufacture for drying or wiping a surface or protecting a surface from soiling. In particular, the present invention relates to toweling articles that are specifically engineered for particular uses.

### BACKGROUND OF THE INVENTION

In modern times, physical fitness has become of greater interest. People have achieved their fitness goals through an increasingly diverse number of sport-related activities, such as swimming, running, weight lifting, mountain biking, and other such sports. This increase in sport-related activities correlates to an increase in exposure to different types of moisture and soilage, not the least of which include, sweat, mud, grit, grime, pool water, shower water, even blood.

Despite these changes in physical fitness, the common towel remains the article of choice for drying or wiping a surface or protecting a surface from soiling. Today, all towels are basically a single layer fabric made of a uniform absorbent material. The common towel is inadequate to meet the needs of today's athletes.

Accordingly, there is a need for tactical, situation-specific moisture management tools that are more effective then common towels.

### SUMMARY OF THE INVENTION

The present invention is directed to articles of manufacture for drying or wiping a surface or protecting a surface from soiling. By alternating different configurations of microfiber, moisture-resistant and moisture-permeable fabrics, a novel and more advanced material is created that better serves the needs of today's active society. The present invention provides situation-specific moisture management tools that are customizable depending on the requirements and activities of the user.

### BRIEF DESCRIPTION OF THE DRAWINGS

While the specification concludes with claims particularly pointing out and distinctly claiming the subject matter, which is regarded as defining the present invention, it is believed that the invention will be better understood from the following description taken in conjunction with the following accompanying drawings:

FIG. 1 is an illustration of a cross-section of one embodiment of the present invention;

FIG. 2A is an illustration of a front view of one embodiment of the present invention;

FIG. 2B is an illustration of a rear view of one embodiment of the present invention;

FIG. 3A is an illustration of a front view of another embodiment of the present invention; and

FIG. 3B is an illustration of a rear view of another embodiment of the present invention.

### DETAILED DESCRIPTION OF THE INVENTION

The present invention is directed to situation specific towels that are generally configured for wiping a surface, e.g., skin, body part, or equipment, or for protecting a surface from soiling. These situation specific towels generally have a first layer for wiping, cleaning, or moisture absorption and a second layer for moisture resistance. Although each layer may conform to the shape and size of the other layer, the layers may have different shapes and sizes so that the towel may have multiple layers in certain areas and a single layer in other areas.

The layer for wiping, cleaning, or moisture absorption can include a fabric. The term “fabric,” as used herein, means a cloth-like material made from fibers. Fabrics can be made from an ordered arrangement of fibers or a mesh of fibers. Fabrics can be textiles, which are typically made by knitting or weaving fibers made of various natural and/or synthetic materials. As is well known in the art, the fabric characteristics (e.g., texture) are determined by the fiber characteristics and the weave characteristics. The fibers can have a variety of mechanical, structural and chemical characteristics. For example, natural and synthetic fibers can be used, and the fibers can be treated with coatings to make the fiber more hydrophilic or increase their strength. Fibers can also be tailored to have a desired cross-sectional shape. Similarly, changing the variables for the weaving or knitting process can modify the characteristics of the fabric. These variables include, but are not limited to, weave patterns (e.g., single knit, double knit, and waffle patterns), loop characteristics (e.g., length, depth, and breadth of the loop), fiber angles, individual fiber exposure, pile characteristics, and combinations thereof. By changing the fiber characteristics and the weave characteristics, the textile manufacturer can produce a fabric that has any number of desired characteristics. For example, desirable fabric characteristics for toweling applications include moisture wicking ability, moisture absorbing ability, wiping ability, scrubbing ability, cleaning ability, and combinations thereof.

Each fabric layer of the present invention can be made from any fabric known to the skilled artisan. Useful natural fabrics include, but are not limited to, fabrics made from natural fibers, such as cotton, silk, linen, and combinations thereof. Useful synthetic fabrics include, but are not limited to, fabrics made from synthetic fibers, such as polyester, polyamide (nylon), rayon, acrylic, and combinations thereof. Fabrics can be obtained from any combination of the fibers described above, wherein the fibers have a weight from about 35 grams to about 850 grams/m².

Preferably, a fabric layer is made of a synthetic fiber having a denier of from about 0.01 to about 50, referred hereinafter as microfiber fabric. The fabric layer is more preferably made of a microfiber having a denier of from about 0.01 to about 0.99. The fabric layer can utilize a split microfiber, unsplit microfiber, or a combination thereof. Nonlimiting examples of useful materials include: microfiber fabrics, such as MFT 1, 2, 3, 5, 8, 11.3, and 35, 1100, SU1 and SU3, which are commercially available from Leading Edge Products located in San Diego, Calif.; microfibers made with polyester and polyamide in a weight percentage ratio ranging from about 50/50 to about 90/10; microfibers made from 100% polyester; and microfibers made from 100% polyamide (nylon). Microfibers are usefuil because after the fibers are spun extruded, they can be split to create furrows and channels. These furrows and channels help provide a capillary action, which draws moisture into the void spaces. Since there can be from about 90,000 to about 180,000 microfibers per sq. in., the fabric has a large surface area available for contact with a moist surface. Similarly, the large number of fibers also provides a proportional amount of capillary action and void space into which the moisture can be drawn.

The layer for moisture resistance can include any material known in the art that prevents or hinders passage of water and other fluids through it. Accordingly, moisture-resistant materials can include water-resistant materials and waterproof materials. The moisture-resistant material is preferably flexible, and it is also preferably machine washable. Examples of suitable moisture-resistant materials include, but are not limited to, plastics, such as polyester, polyamide (nylon), rayon, acrylic, acrylonitryl butadiene styrene (ABS), polystyrene, polyethylene, polypropylene, polyurethane and combinations thereof; Goretexe-like fabrics; SBR open cell sponge; rubber containing materials; and combinations thereof.

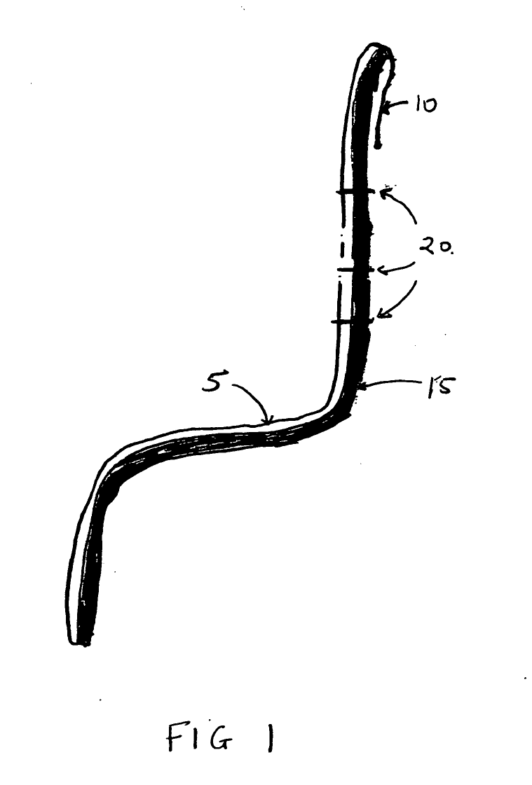

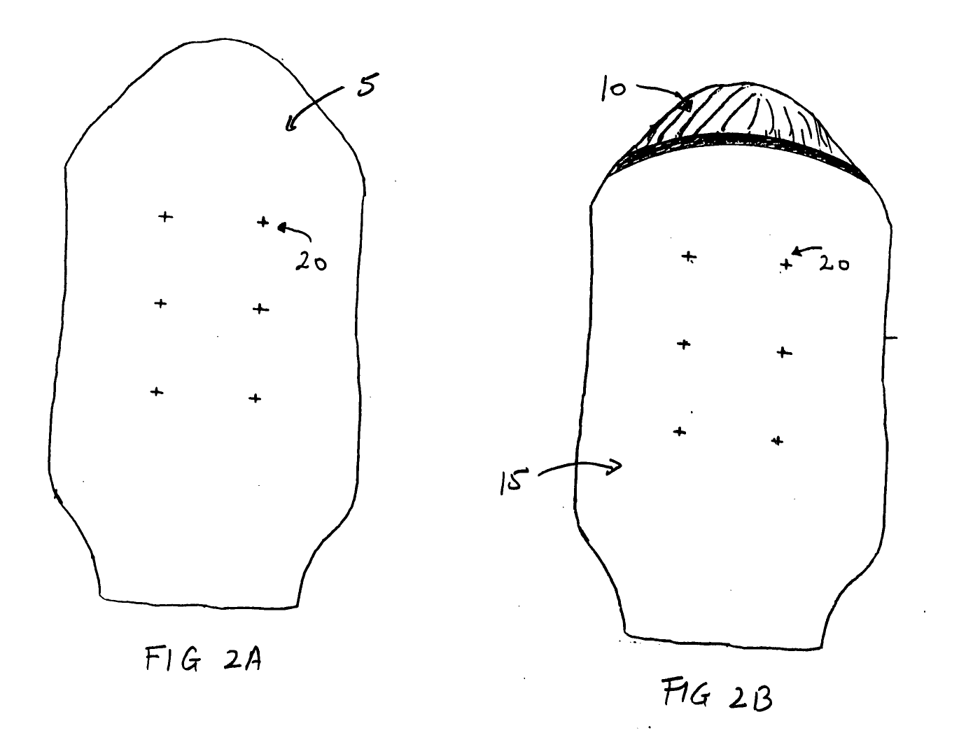

In one embodiment, the present invention is directed to a seat cover configured to protect a seat, such as a car seat, from soiling. The seat typically has at least a seat portion and a back portion, and can also have a headrest portion. FIGS. 1, 2A and 2B illustrate one particular embodiment positioned onto a seat (not illustrated). FIG. 1 is a cross-section view, FIG. 2A is a front view, and FIG. 2B is a rear view. In this embodiment, the seat cover includes a microfiber fabric layer 5, e.g., a terry microfiber, and a moisture-resistant layer 15, e.g., 0.125 inch thick SBR medium open cell foam rubber. The fabric layer can help to wick way and store moisture, while the moisture-resistant layer protects the seat.

The microfiber fabric layer is preferably cut to generally conform to the contours of a seat, e.g., the fabric layer can be cut to be a unitary layer having a seat portion, a back portion, and a head rest portion. The fabric layer can also include a hood portion 10, which is sufficient to cover the front surface of the head rest and at least a part of the rear surface of the head rest. Alternatively, the hood can be formed by coupling a separate layer of a microfiber fabric or moisture-resistant material. The hood portion is preferably made of a single layer of woven microfabric fabric, thereby minimizing material and assembly costs. The moisture-resistant layer 15 is also preferably cut to generally conform to the contours of a seat, e.g., the fabric layer can be cut to have a seat portion, a back portion, and a head rest portion.

The two layers can be coupled together by any method known to the skilled artisan, as discussed below in greater detail. In this embodiment, the two layers are stitched together along the periphery of moisture-resistant layer. Then the sides of the hood portion is stitched to edges of the back side of the moisture-resistant layer, thereby leaving the bottom of the hood portion free to form the hood. The two layers can also be further coupled by using stitching in the internal surface areas, e.g., as illustrated by cross-stitches 20. The internal surface areas of the two layers can also be coupled using substantially parallel lines of stitching, as described in greater detail below.

In another embodiment, the present invention is directed to a fishing chap for wiping and drying hands during fishing and cleaning of fish. The fishing chap is configured to be attached to a fisherman's leg and cover at least a portion of the leg. The fishing chap includes a first fabric layer, a second moisture-resistant layer coupled to the first layer, and a body attachment mechanism. The fabric layer can be any fabric described above, but is preferably a microfiber fabric layer, and the moisture-resistant layer can be any material described above for moisture resistance. The body attachment mechanism can be one or more leg straps and can further include a belt strap. The fishing chap can further include a non-slip surface on the uncoupled surface of the moisture-resistant layer. This embodiment also encompasses a pair of chaps, wherein each chap has a different fabric layer. For example, one chap can have rough surface for scrubbing, such as a terry microfiber, and the other chap can have a softer surface for drying, such as MFT8 microfiber.

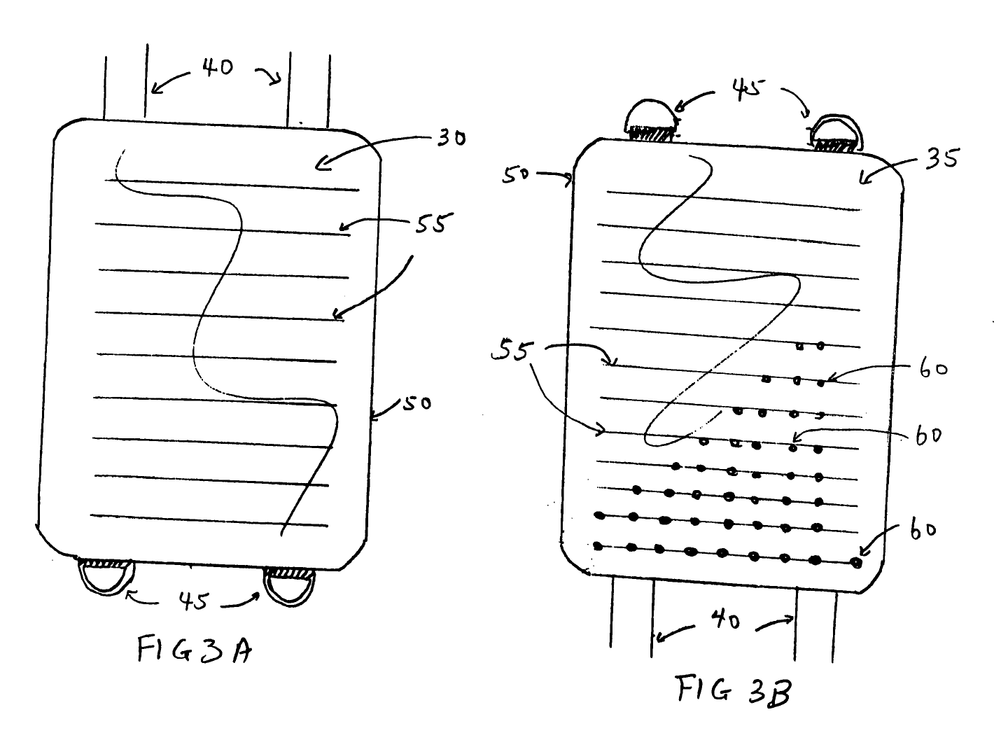

One embodiment of a fishing chap is illustrated in FIGS. 3A and 3B, wherein FIG. 3A illustrates a front view of the chap and FIG. 3B illustrates a rear view. In this particular embodiment, a substantially square fabric layer 30, such as a terry microfiber, is coupled to a substantially square moisture-resistant layer 35, such as nylon, by stitching 50 along the periphery of the two layers. Additional parallel lines of stitching 55 can also be used to couple the inner surface areas of the layers. Note that the layers can be cut in any geometric shape, and that the two layers can also be coupled together by any method known to the skilled artisan, as discussed below in greater detail. A pair of leg straps 40 and strapped “D” rings 45 serve as the body attachment mechanism in this particular embodiment. Leg straps 40 are stitched onto one edge of the two coupled layers, and the strap portion of the “D” rings 45 are stitched onto an opposite edge at a corresponding location to leg straps 40. Lastly, this particular embodiment further includes a non-slip surface in the form of a plurality of friction dots 60 on the uncoupled side of the moisture-resistant layer. These friction dots can be made of rubber and can be easily placed onto the uncoupled side of the moisture-resistant layer by any method known in the art, such as silk screening.

In another embodiment, the present invention is directed to a three-layered towel for cleaning objects, such as a bicycle chain. This three-layered towel includes a first fluid permeable layer, a second moisture-resistant layer coupled to the first layer, and a third moisture-absorbing layer coupled in between the first and second layers. The middle, moisture-absorbing layer is utilized for holding fluids, such as a cleaning fluid, while the first fluid permeable layer is utilized for wiping and cleaning while dispensing the fluid. The three-layered cleaning towel of this embodiment can also include a hand strap attached to the uncoupled side of the moisture-resistant layer to help maintain the users hand on the cleaning towel.

In this embodiment, the first fluid permeable layer can including any of the fabrics described above. The first fluid permeable layer can also including any of the moisture-resistant materials described above, as long as there is sufficient structures, such as perforations, to allow passage of fluid from the moisture-absorbing layer. The moisture-absorbing layer can including any of the fabrics described above, and the moisture-resistant layer can including any of the moisture-resistant materials described above. The three layers can be coupled by any method known in the art, as described in greater detail below.

In one particular embodiment, the three-layered towel for cleaning objects has a top layer made of a jersey material, a middle layer made of a microfiber terry, and a bottom layer made of a nylon moisture barrier. The three layers are coupled by stitching along the periphery, and can be further coupled by quilting the inner surface areas of the layers together.

The layers of the situation-specific towels described above can be coupled together by any method known to the skilled artisan. For example, the two or more layers can be coupled together by stitching, gluing, bonding (such as, by utilizing heat, pressure, fusion, a chemical agent, or any combination thereof), melt blowing, and the like. It is preferable to use a coupling method that allows repeated washing and drying. The layers of the towel are more preferably stitched together, and most preferably stitched together utilizing substantially parallel lines of stitching. The substantially parallel lines of stitching can have curves and can intersect at the edges of the towel. Without being limited to any one theory, it is believed that substantially parallel lines of stitching allows quicker hang drying of the multi-layered towels of the present invention by creating channels to help direct moisture to the edges. This feature would be especially helpful for embodiments described herein that are designed to absorb large amounts of moisture.

While several embodiments of the present invention have been illustrated by way of example, it is apparent that further embodiments could be developed within the spirit and scope of the present invention. However, it is to be expressly understood that such modifications and adaptations are within the spirit and scope of the present invention, as set forth in the following claims.

What is claimed is:

1. An article of manufacture for protecting a car seat, the car seat having a seat portion, a back portion, and a headrest portion, the article comprising:
a first layer comprising a woven microfiber fabric, the first layer having a seat portion, and a back portion,
a second layer comprising a moisture-resistant material, the second layer having a first side coupled to the first layer and at least a seat portion and a back portion; and
a hood consisting of a woven microfiber fabric, wherein the hood is configured to slip over the headrest of a car seat and the peripheral edges of the hood portion is coupled to the peripheral edges of the second layer to form a hood that conforms to the shape of the headrest of the seat.

2. The article of claim 1, wherein the hood portion is an integral part of the first layer.

3. The article of claim 1, wherein the microfiber fabric is selected from the group consisting of fabrics made from natural fibers, fabrics made from synthetic fibers, and combinations thereof; and wherein the moisture-resistant material is selected from plastics, Gortex-like fabrics, rubber-containing materials, and combinations thereof.

4. The article of claim 1, wherein the first and second layers are coupled by stitching along the periphery.

5. The article of claim 4, wherein the first and second layers are further coupled by spot stitching in the inner surface areas of the layers.

6. The-article of claim 4, wherein the first and second layers are further coupled by utilizing substantially parallel lines of stitching along the inner surface areas of the layers comprising at least the seat and back portions of the chair.

7. An article of manufacture for wiping hands during fishing, comprising:
a chap, comprising,
a first fabric layer;
a second moisture-resistant layer coupled to the first layer; and
a body attachment mechanism coupled to the chap

8. The article of claim 7, wherein the first layer comprises a fabric selected from the group consisting of fabrics made from natural fibers, fabrics made from synthetic fibers, and combinations thereof; and wherein the second layer comprises a material selected from the group consisting of plastics, Gortex-like fabrics, rubber-containing materials, and combinations thereof.

9. The article of claim 7, wherein the body attachment mechanism comprises at least one leg strap along one edge of the article and a corresponding strap connector along an opposite edge of the article.

10. The article of claim 9, wherein the body attachment mechanism comprises at least two leg straps, apart from each other along one edge of the article, and two corresponding strap connectors along an opposite edge of the article.

11. The article of claim 9, wherein the body attachment mechanism further comprises a belt strap.

12. The article of claim 7, wherein the uncoupled side of the second layer further comprises a non-slip surface.

13. The article of claim 12, wherein the non-slip surface is in the form of a plurality of dots.

14. An article of manufacture for wiping hands during fishing, comprising:
a first chap, comprising,
a first fabric layer;
a second moisture-resistant layer, the second layer coupled to the first layer; and
a body attachment mechanism coupled to the chap; and
a second chap, comprising,
a first fabric layer;
a second moisture-resistant layer, the second layer coupled to the first layer; and
a body attachment mechanism coupled to the chap; and.

15. The article of claim 14, wherein the first layer of both chaps comprises a fabric independently selected from the group consisting of fabrics made from natural fibers, fabrics made from synthetic fibers, and combinations thereof; and wherein the moisture-resistant layer comprises a material selected from the group consisting of plastics, Gortex-like fabrics, rubber-containing materials, and combinations thereof.

16. The article of claim 15, wherein the fabric of the first layer of first chap is different from the fabric of the first layer of the second chap.

17. The article of claim 14, wherein the fabric of the first chap comprises a microfiber terry, wherein the fabric of the second chap comprises a microfiber chamois; and wherein the moisture-resistant material comprises nylon.

18. The article of claim 14, wherein the body attachment mechanism of each chap comprises at least one leg strap along one edge of the article and a corresponding strap connector along an opposite edge of the article.

19. The article of claim 14, wherein the body attachment mechanism of each chap comprises at least two leg straps, apart from each other along one edge of the article, and two corresponding strap connectors along an opposite edge of the article.

20. The article of claim 18, wherein the body attachment of each chap further comprises a belt strap.

21. The article of claim 14, wherein the free side of the second layer of each chap further comprises a non-slip surface.

22. The article of claim 21, wherein the non-slip surface is in the form of a plurality of dots.

23. An article of manufacture for cleaning, comprising:
a first fluid permeable layer;
a second moisture-resistant layer coupled to the first layer; and
a third moisture absorbing layer coupled in between the first and second layers.

24. The article of claim 23, wherein the first layer comprises a material selected from the group consisting of fabrics made from natural fibers, fabrics made from synthetic fibers, perforated moisture resistant materials, and combinations thereof; wherein the second layer comprises a material selected from the group consisting of plastics, Gortex-like fabrics, rubber-containing materials, and combinations thereof; and wherein the third layer comprises a material selected from the group consisting of fabrics made from natural fibers, fabrics made from synthetic fibers.

25. The article of claim 24, wherein the first layer comprises a jersey material; wherein the second layer comprises nylon; and wherein the second layer comprises a terry microfiber.
